(19) United States
(12) Patent Application Publication
(10) Pub. No.: US 2010/0072383 A1
(43) Pub. Date: Mar. 25, 2010

(54) RADIATION DETECTING ELEMENT

(75) Inventor: Yoshihiro OKADA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/557,539

(22) Filed: Sep. 11, 2009

(30) Foreign Application Priority Data
Sep. 25, 2008 (JP) 2008-246421

(51) Int. Cl. G01T 1/24

(52) U.S. Cl. 250/370.09

(57) ABSTRACT

The present invention provides a radiation detecting element that can obtain radiation images by X-rays of different energies by irradiation of X-rays at a single time, without positional offset arising. X-ray detecting sections, that generate charges corresponding to irradiated X-rays, are provided at an obverse side and a reverse side of a substrate. At each pixel, the X-ray detecting sections are disposed so as to be layered with respect to a direction of irradiation of X-rays.

### CROSS-REFERENCE TO RELATED APPLICATION

This application claims priority under 35 USC 119 from Japanese Patent Application No. 2008-246421, filed on Sep. 25, 2008, the disclosure of which is incorporated by reference herein.

### BACKGROUND OF THE INVENTION

1. Field of the Invention

The present invention relates to a radiation detecting element. In particular, the present invention relates to a radiation detecting element that detects an image expressed by irradiated radiation.

2. Description of the Related Art

X-ray detecting elements such as FPDs (flat panel detectors), in which an X-ray sensitive layer is disposed on a TFT (thin film transistor) active matrix substrate and that can convert X-ray information directly into digital data, and the like have been put into practice in recent years. As compared with a conventional imaging plate, an X-ray detecting element has the advantages that an image can be confirmed immediately and video images as well can be confirmed, and the popularization of X-ray detecting elements has advanced rapidly.

Various types of such X-ray detecting elements have been proposed. For example, there is a direct-conversion-type X-ray detecting element that converts X-rays directly into charges at a semiconductor layer, and accumulates the charges. Moreover, there is an indirect-conversion-type X-ray detecting element that once converts X-rays into light at a scintillator (a wavelength converting portion) of CsI:Tl, GOS (Gd2O2S:Tb), or the like, and, at sensor portions such as photodiodes or the like, converts the converted light into charges, and accumulates the charges.

The following technique is known in the photographing of radiation images. The same region of a subject is photographed at different tube voltages, and image processing (hereinafter called “subtraction image processing”), that weights the radiation images obtained by the photographings at the respective tube voltages and computes the difference therebetween, is carried out. A radiation image (hereinafter called “energy subtraction image”) is obtained in which one of an image portion, that corresponds to hard tissue such as bones or the like within the image, and an image portion, that corresponds to soft tissue, is emphasized and the other is removed. For example, with an energy subtraction image that emphasizes the image portion corresponding to soft tissue of the chest region, pathological changes that are hidden by the ribs can be seen and diagnostic performance can be improved.

In the case when obtaining an energy subtraction image with an analog X-ray film or an imaging plate, X-rays are irradiated a single time while two X-ray films or imaging plates are superposed one on the other, and the energy subtraction image can be obtained by carrying out subtraction image processing on the two radiation images that are obtained from the respective X-ray films or imaging plates.

On the other hand, with an X-ray detecting element, there a method of photographing that, when an energy subtraction image is to be obtained, X-rays of different energies are irradiated two times in succession with respect to a single X-ray detecting element, and two radiation images are obtained. Further, with an X-ray detecting element, there is a method in which, when an energy subtraction image is to be obtained, two radiation images are obtained by irradiating X-rays one time with two X-ray detecting elements superposed one on the other, similarly to the case of X-ray films or imaging plates.

The former photographing method has the drawback that, by carrying out irradiation of X-rays twice, the amount of radiation to which the subject is exposed increases. Further, the former photographing method has the fundamental drawback of image offset between the two times irradiation is carried out.

In contrast, the latter photographing method has the drawback that image quality deteriorates due to offset between the two X-ray detecting elements that is caused by dimensional errors from the time of manufacturing the X-ray detecting elements, or by vibration or expansion. Further, this latter photographing method also has the drawback that, because the X-rays are irradiated radially from the X-ray source, if two of the X-ray detecting elements are superposed one on the other, the pixel sizes of the radiation images that are obtained from the respective X-ray detecting elements differ. Still further, there is the drawback that costs in the latter photographing method are higher than in a case of using a single X-ray detecting element.

Thus, the present applicants have, in Japanese Patent Application Laid-Open (JP-A) No. 2000-298198, disclosed a technique in which, when an energy subtraction image is obtained by layering plural individual radiation detecting layers at an X-ray detecting element and carrying out subtraction image processing on the radiation images obtained from the respective individual radiation detecting layers, correction of the pixel size is carried out so that the pixel sizes of the respective radiation images become the same.

However, in a case of obtaining radiation images by X-rays of different energies by the irradiation of X-rays a single time, it is preferable that there be no positional offset among the respective radiation images.

Note that the above explanation mentions the case of X-rays because X-rays are the object of detection of an X-ray detecting element, but the same holds in cases of obtaining a radiation image when the object of detection is radiation such as gamma rays, neutron beams, or the like.

### SUMMARY OF THE INVENTION

The present invention provides a radiation detecting element that can obtain radiation images by radiation of different energies by the irradiation of X-rays a single time, without positional offset arising.

A radiation detecting element of a first aspect includes: an insulating substrate in which is formed a through-hole that opens at an obverse side and a reverse side of the insulating substrate and in which a conductor is formed; radiation detecting sections provided respectively at the obverse side and the reverse side of the insulating substrate, and generating charges corresponding to irradiated radiation; a first switching element provided at one of the obverse side and the reverse side of the insulating substrate and connected to the radiation detecting section provided at the one of the obverse side and the reverse side of the insulating substrate, for reading-out charges generated at that radiation detecting section; and a second switching element, provided at the one of the obverse side and the reverse side of the insulating substrate and connected via the conductor of the through-hole to the radiation detecting section provided at the other of the obverse side and the reverse side of the insulating substrate, for reading-out charges generated at that radiation detecting section.

In the radiation detecting element of the first aspect, the radiation detecting sections are provided respectively at the obverse side and the reverse side of the insulating substrate in which is formed the through-hole that opens at an obverse side and a reverse side and in which a conductor is formed. The radiation detecting sections generate charges corresponding to irradiated radiation.

In the radiation detecting element of the first aspect, the first switching element and the second switching element are provided at one of the obverse side and the reverse side of the insulating substrate. The first switching element is connected to the radiation detecting section that is provided at the one of the obverse side and the reverse side of the insulating substrate. The second switching element is connected, via the conductor of the through-hole, to the radiation detecting section that is provided at the other of the obverse side and the reverse side of the insulating substrate. The first switching element reads-out the charges that are generated at the radiation detecting section that is provided at the one of the obverse side and the reverse side. The second switching element reads-out the charges that are generated at the radiation detecting section that is provided at the other of the obverse side and the reverse side.

In this way, in accordance with the first aspect, the radiation detecting sections, that generate charges corresponding to irradiated radiation, are provided respectively at the obverse side and the reverse side of the insulating substrate, and the radiation detecting sections are disposed so as to be layered with respect to the direction in which radiation is irradiated. Accordingly, the radiation detecting element of the first aspect obtains radiation images by radiation of different energies by the irradiation of radiation a single time, without positional offset arising.

In a second aspect, in the above-described aspect, the through-hole, the radiation detecting sections, the first switching element and the second switching element may be provided for each pixel region that corresponds to a pixel of a radiation image and detects radiation.

In a third aspect, in the above-described aspect, the radiation detecting section that is provided at the one of the obverse side and the reverse side of the insulating substrate, and the first switching element, may be provided for each pixel region that corresponds to a pixel of a radiation image and detects radiation, and the radiation detecting section that is provided at the other of the obverse side and the reverse side of the insulating substrate, and the through-hole and the second switching element, may be provided per a plurality of the pixel regions.

In a fourth aspect, in the above-described aspect, the through-hole may be disposed at a position that is superposed with the radiation detecting section that is provided at the other of the obverse side and the reverse side of the insulating substrate.

In a fifth aspect, in the above-described aspect, the radiation detecting section that is at a non-irradiated side may have higher sensitivity to high energy radiation than the radiation detecting section that is at an irradiated side where radiation is irradiated.

In a sixth aspect, in the above-described aspect, the radiation detecting section that is at an irradiated side where radiation is irradiated may be configured to include a semiconductor layer that generates charges when radiation is irradiated, and the radiation detecting section that is at a non-irradiated side may be configured to include a wavelength converting portion that generates light when radiation is irradiated, and a sensor portion that generates charges due to illuminated light that is generated at the wavelength converting portion.

In a seventh aspect, in the above-described aspect, the radiation detecting section that is at a non-irradiated side may have, at an irradiated side, a filter that absorbs low energy radiation.

In an eighth aspect, in the above-described aspect, the radiation detecting section at the irradiated side may also function as the filter.

The radiation detecting element of the present invention obtains radiation images by radiation of different energies by the irradiation of radiation a single time, without positional offset arising.

### BRIEF DESCRIPTION OF THE DRAWINGS

An exemplary embodiment of the present invention will be described in detail based on the following figures, wherein:

FIG. 1 is a structural drawing showing the overall configuration of a radiation image photographing device relating to an exemplary embodiment;

FIG. 2 is a schematic drawing showing the schematic configuration of one pixel of an X-ray detecting element relating to the exemplary embodiment;

FIG. 3 is a plan view showing the configuration of the X-ray detecting element relating to the exemplary embodiment;

FIG. 4 is a line cross-sectional view of the X-ray detecting element relating to the exemplary embodiment;

FIG. 5 is a schematic drawing showing the flow of X-rays that are incident on one pixel of the X-ray detecting element relating to the exemplary embodiment;

FIG. 6 is a graph showing X-ray absorption characteristics of respective types of materials;

FIG. 7 is a schematic drawing showing the schematic configuration of one pixel of an X-ray detecting element relating to another form;

FIG. 8 is a schematic drawing showing the schematic configuration of one pixel of an X-ray detecting element relating to yet another form.

### DETAILED DESCRIPTION OF THE INVENTION

Hereinafter, a case in which the present invention is applied to a radiation image photographing device 100, that photographs radiation images by radiation such as X-rays or the like, will be described with reference to the drawings.

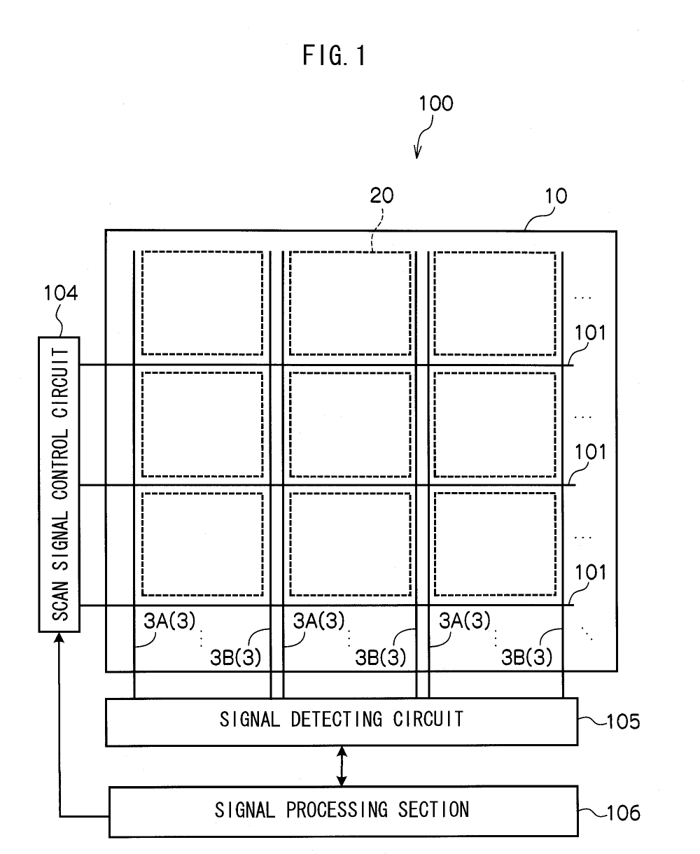

The overall configuration of the radiation image photographing device 100 relating to the present exemplary embodiment is shown in FIG. 1.

As shown in FIG. 1, the radiation image photographing device 100 relating to the present exemplary embodiment has an X-ray detecting element 10.

As shown in FIG. 1, at the X-ray detecting element 10, plural pixels 20, that detect X-rays as information of pixels structuring a radiation image, are provided in the form of a matrix in one direction (the horizontal direction in FIG. 1) and in a direction (the vertical direction in FIG. 1) intersecting the one direction.

Scan lines 101 are provided in parallel at the X-ray detecting element 10, with each of the scan lines 101 corresponding to a row of pixels in the one direction. Further, signal lines 3 are provided in parallel at the X-ray detecting element 10, with the signal lines 3 corresponding to columns of pixels in the intersecting direction. Note that, at the X-ray detecting element 10 relating to the present exemplary embodiment, two of the signal lines 3 (3A, 3B) are provided for each of the pixel columns in the intersecting direction. The signal line 3A is provided at one side (the left side in FIG. 1) of the pixels 20 in a pixel column. The signal line 3B is provided at the other side (the right side in FIG. 1) of the pixels 20 in a pixel column.

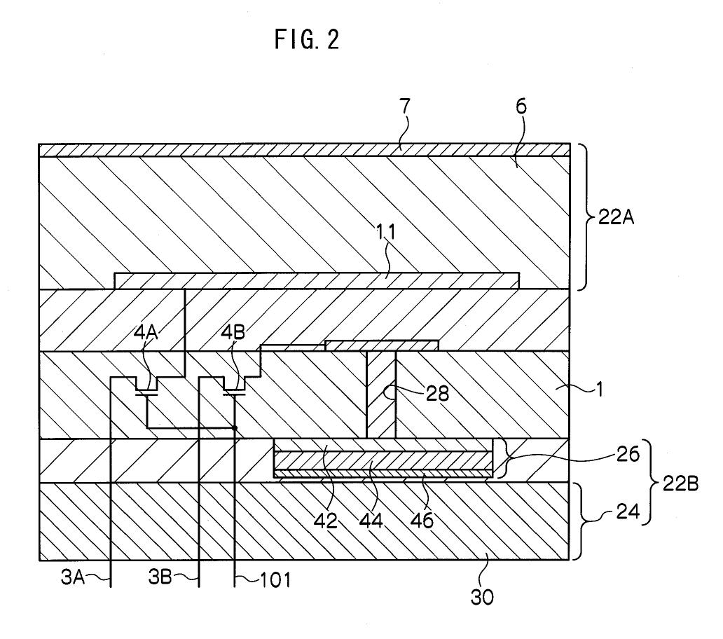

A schematic drawing illustrating the schematic configuration of one of the pixels 20 of the X-ray detecting element 10 relating to the exemplary embodiment is shown in FIG. 2.

As shown in FIG. 2, two X-ray detecting sections 22A, 22B are provided at the pixel 20, at the obverse side and at the reverse side of a substrate 1, respectively. The two X-ray detecting sections 22A, 22B generate charges corresponding to radiation that is irradiated.

A through-hole 28, that opens at the obverse side and the reverse side of the substrate 1, is formed in the substrate 1. A conductor is formed at the interior of the through-hole 28.

The X-ray detecting section 22A is a direct-conversion-type that converts X-rays directly into charges, and accumulates the charges. The X-ray detecting section 22A has a semiconductor layer 6 that generates charges when X-rays are irradiated.

The X-ray detecting section 22B is an indirect-conversion-type that converts X-rays into light once, and thereafter, converts the light into charges and accumulates the charges. The X-ray detecting section 22B has a wavelength converting portion 24 that generates light when X-rays are irradiated, and a sensor portion 26 that generates charges due to the light, that is generated at the wavelength converting portion 24, being illuminated.

A TFT switch 4A, that is for reading-out the charges that are generated at the X-ray detecting section 22A, and a TFT switch 4B, that is for reading-out the charges that are generated at the X-ray detecting section 22B, are provided at the pixel 20.

The source of the TFT switch 4A is connected to the X-ray detecting section 22A, the drain is connected to the signal line 3A, and the gate is connected to the scan line 101. The source of the TFT switch 4B is connected to the X-ray detecting section 22B via the conductor in the through-hole 28, the drain is connected to the signal line 3B, and the gate is connected to the scan line 101.

Due to any of the TFT switches 4A that are connected to the signal line 3A being turned on, an electric signal corresponding to the charge amount that is generated and accumulated at the X-ray detecting section 22A flows to the signal line 3A. Due to any of the TFT switches 4B that are connected to the signal line 3B being turned on, an electric signal corresponding to the charge amount that is generated and accumulated at the X-ray detecting section 22B flows to the signal line 3B.

A signal detecting circuit 105 (see FIG. 1), that detects the electric signals that flow-out to the respective signal lines 3A, 3B, is connected to the signal lines 3A, 3B. A scan signal control circuit 104, that outputs to the scan lines 101 control signals for turning the TFT switches 4A, 4B ON and OFF, is connected to the respective scan lines 101.

An amplifying circuit that amplifies the inputted electric signal is incorporated in the signal detecting circuit 105 for each of the signal lines 3A, 3B. The signal detecting circuit 105 amplifies, by the respective amplifying circuits, the electric signals that are inputted from the respective signal lines 3A, 3B, and detects the signals. Due thereto, the signal detecting circuit 105 detects, as information of the respective pixels structuring the image, the charge amounts that are generated at the two X-ray detecting sections 22A, 22B of the respective pixels 20.

A signal processing device 106 is connected to the signal detecting circuit 105 and the scan signal control circuit 104. The signal processing device 106 outputs control signals expressing signal detecting timings with respect to the signal detecting circuit 105 and outputs control signals expressing scan signal outputting timings with respect to the scan signal control circuit 104. Further, the signal processing device 106 divides the information of the respective pixels that are detected at the signal detecting circuit 105, into image information from the signal lines 3A and image information from the signal lines 3B, and carries out predetermined processing thereon. Note that, in the present exemplary embodiment, the respective signal lines 3A, 3B are connected to the one signal detecting circuit 105. However, two of the signal detecting circuits 105 may be provided, and the signal lines 3A and the signal lines 3B may be connected to the separate signal detecting circuits 105. Due thereto, a signal detecting circuit, that is used in a conventional X-ray detecting element that detects one radiation image, can be utilized.

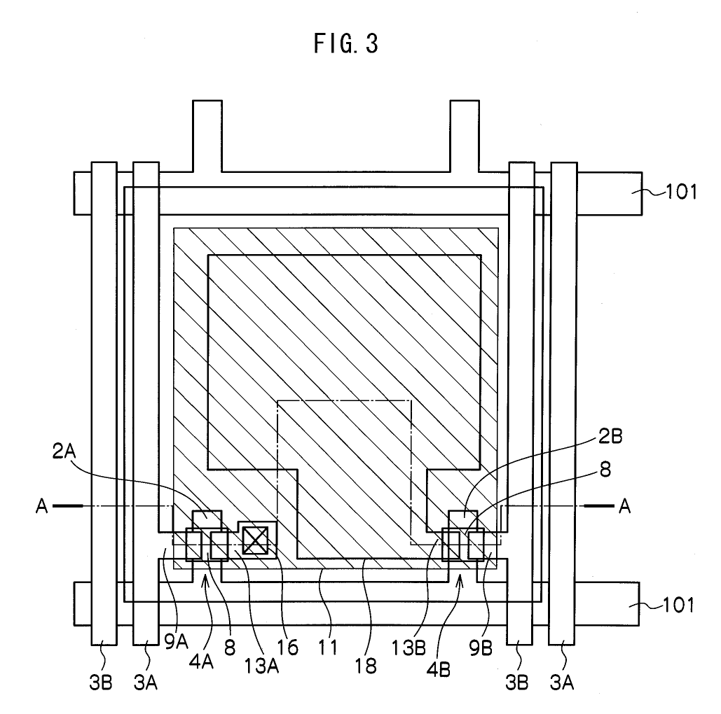

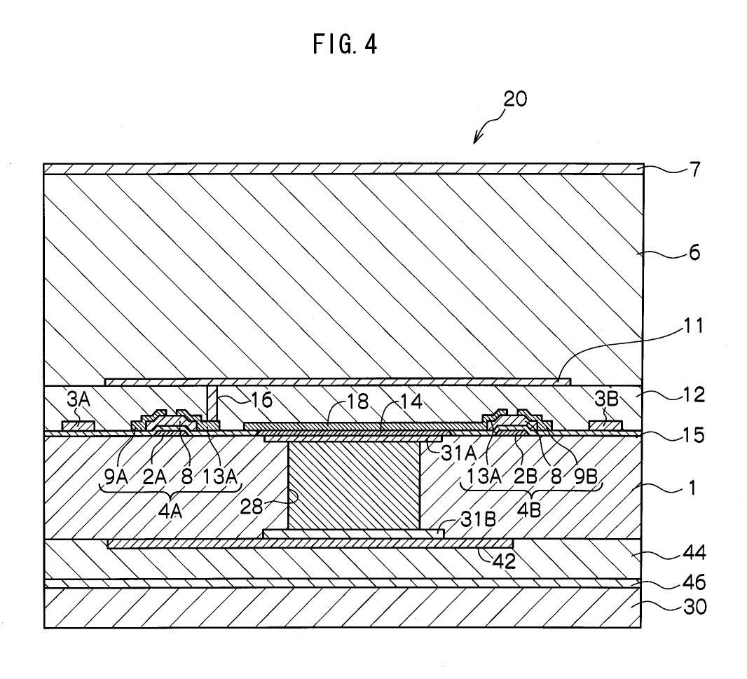

Next, the X-ray detecting element 10 relating to the present exemplary embodiment will be described in further detail with reference to FIG. 3 and FIG. 4. Note that a plan view showing the configuration of one pixel unit of the X-ray detecting element 10 relating to the present exemplary embodiment is shown in FIG. 3. A cross-sectional view along line A-A of FIG. 3 is shown in FIG. 4.

As shown in FIG. 4, the X-ray detecting element 10 relating to the present exemplary embodiment has the flexible printed (FPC) substrate (hereinafter called “substrate”) 1 that uses an insulator such as polyimide or the like. The through-hole 28, that is open at the obverse side and the reverse side of the substrate 1 and in which a conductor is formed, is formed in the substrate 1 at each of the pixel regions at which the pixel 20 is provided. Further, metal caps 31A, 31B are formed at the substrate 1 at the obverse and reverse portions of the through-hole 28. The metal cap 31A and the metal cap 31A are electrically connected by the through-hole 28. The technique of forming the through-holes 28 and the metal caps 31A, 31B at the substrate 1 is disclosed in, for example, Fujikura Giho, No. 108 (April 2005), pp. 44-47, “FPC Mass-Production Techniques Addressing Market Demands”, and therefore, detailed description thereof is omitted.

The scan line 101 (see FIG. 4), two gate electrodes 2A, 2B and a contact 14 are formed on the substrate 1. The gate electrodes 2A, 2B are respectively connected to the scan line 101 (see FIG. 3). The contact 14 is connected to the metal cap 31A. The wiring layer in which the scan line 101, the gate electrodes 2A, 2B and the contact 14 is formed (hereinafter, this wiring layer will also be called a “first signal wiring layer”) is formed by using Al or Cu, or a layered film formed mainly of Al or Cu, but is not limited to these.

An insulating film 15 is formed on the first signal wiring layer on the surface thereof. The regions of the insulating film 15, which regions are positioned on the gate electrodes 2A, 2B, act as gate insulating films at the TFT switches 4A, 4B. The insulating film 15 is formed from, for example, SiNₓ or the like, and is formed by, for example, CVD (Chemical Vapor Deposition).

A semiconductor layer 8 is formed on the insulating film 15 at positions corresponding to the gate electrodes 2A, 2B. The regions of the semiconductor layer 8 that are positioned on the gate electrodes 2A, 2B act as semiconductor active layers (channel portions) at the TFT switches 4A, 4B. The semiconductor layer 8 is formed from, for example, an amorphous silicon film.

Source electrodes 9A, 9B and drain electrodes 13A, 13B are formed on these layers. The source electrodes 9A, 9B and the drain electrodes 13A, 13B, as well as the signal lines 3A, 3B, are formed at the wiring layer at which the source electrodes 9A, 9B and the drain electrodes 13A, 13B are formed. Further, a contact 18 is formed, at a position corresponding to the contact 14, at the wiring layer at which the source electrodes 9A, 9B and the drain electrodes 13A, 13B are formed. The source electrode 9A is connected to the signal line 3A (see FIG. 4). The source electrode 9B is connected to the signal line 3B. The drain electrode 13B is connected to the contact 18. The contact 18 is connected to the contact 14. The wiring layer, in which the source electrodes 9A, 9B, the drain electrodes 13A, 13B, the signal lines 3A, 3B and the contact 18 are formed (hereinafter, this wiring layer will also be called a “second signal wiring layer”), is formed by using Al or Cu, or a layered film formed mainly of Al or Cu. However, the forming of the wiring layer is not limited to these.

A contact layer (not illustrated) is formed between, on the one hand, the source electrodes 9A, 9B and the drain electrodes 13A, 13B, and, on the other hand, the semiconductor layer 8. The contact layer is formed from an impurity doped semiconductor such as an impurity doped amorphous silicon or the like.

At the X-ray detecting element 10 relating to the present exemplary embodiment, the TFT switch 4A is configured by the gate electrode 2A, the gate insulating film 15, the source electrode 9A, the drain electrode 13A and the semiconductor layer 8. Further, in the X-ray detecting element 10 relating to the present exemplary embodiment, the TFT switch 4B is configured by the gate electrode 2B, the gate insulating film 15, the source electrode 9B, the drain electrode 13B and the semiconductor layer 8. Note that, at the TFT switch 4A, the source electrode 9A and the drain electrode 13A are opposite due to the polarities of the charges generated at the X-ray detecting section 22A. Further, at the TFT switch 4B, the source electrode 9B and the drain electrode 13B are opposite due to the polarities of the charges generated at the X-ray detecting section 22B.

An interlayer insulating film 12 is formed on the second signal wiring layer so as to cover the second signal wiring layer, at substantially the entire surface of the region on the substrate 1 where the pixel 20 is provided (substantially the entire region). The interlayer insulating film 12 is formed from an organic material such as an acrylic resin or the like that is photosensitive. The film thickness of the interlayer insulating film 12 is 1 to 4 μm, and the dielectric constant thereof is 2 to 4. In the X-ray detecting element 10 relating to the present exemplary embodiment, the capacity between the metals that are disposed at the upper layer and the lower layer of the interlayer insulating film 12 is kept low by the interlayer insulating film 12. Further, generally, such a material also functions as a flattening (leveling) film, and has the effect of flattening the steps (number of stepped levels due to layered films) of the lower layer. Due thereto, the shape of a semiconductor layer 6 that is disposed at the upper layer is flattened, and therefore, a decrease in the absorption efficiency due to unevenness of the semiconductor layer 6, and an increase in leak current can be suppressed. A contact hole 16 is formed in the interlayer insulating film 12 at a position opposing the drain electrode 13A.

At each of the pixels 20, a lower electrode 11 is formed on the interlayer insulating film 12 so as to cover the pixel region while filling-in the contact hole 16. The lower electrode 11 is formed from an amorphous transparent conductive oxide film (ITO), and is connected to the drain electrode 13A.

The semiconductor layer 6 is formed uniformly on substantially the entire surface of the pixel region, at which the pixel 20 on the substrate 1 is provided, on the lower electrode 11. Due to electromagnetic waves such as X-rays or the like being irradiated thereon, the semiconductor layer 6 generates charges (electron-hole pairs) at the interior thereof. Namely, the semiconductor layer 6 is conductive, and converts the image information by the X-rays into charge information. Further, the semiconductor layer 6 is formed, for example, from amorphous a-Se (amorphous selenium) whose main component is selenium. Here, main component means having a content of greater than or equal to 50%.

An upper electrode 7 is formed on the semiconductor layer 6. A bias power source (not illustrated) is connected to the upper electrode 7, and bias voltage of around several kV is supplied from the bias power source to the upper electrode 7.

On the other hand, at each of the pixels 20, a lower electrode 42 is formed on the reverse of the substrate 1 so as to cover the pixel region. The lower electrode 42 is connected to the metal cap 31B. In a case in which a semiconductor layer 44 that will be described later is thick at around 1 μm, there are hardly any limitations on the material of the lower electrode 42 provided that it is conductive. Therefore, there is no problem with forming the lower electrode 42 by using a conductive metal such as an Al material, ITO (indium tin oxide) or the like.

On the other hand, if the film thickness of the semiconductor layer 44 is thin (around 0.2 to 0.5 μm), the absorption of light at the semiconductor layer 44 is insufficient. Therefore, in the present exemplary embodiment, it is preferable that the semiconductor layer 44 be an alloy, or a layered film, formed mainly of a light-blocking metal for the purpose of preventing an increase in leak current due to the illumination of light onto the TFT switches 4A, 4B.

The semiconductor layer 44 that functions as a photodiode is formed uniformly on the lower electrode 42, on substantially the entire surface of the pixel region. In the present exemplary embodiment, a photodiode of a PIN structure is employed as the semiconductor layer 44, and the semiconductor layer 44 is formed by layering an n⁺ layer, an i layer and a p⁺ layer in that order from the lower layer. Note that, in the present exemplary embodiment, the semiconductor layer 44 is formed uniformly on substantially the entire surface, but the semiconductor layer 44 may be provided so as to be divided per pixel region.

An upper electrode 46 is formed on the semiconductor layer 44. A material having high light-transmittance such as, for example, ITO or IZO (indium zinc oxide) or the like, is used for the upper electrode 46.

A bias power source (not illustrated) is connected to the upper electrode 46, and bias voltage of around several tens of V is supplied from the bias power source to the upper electrode 46. Note that, as compared with a low-resistance wiring material such as aluminum or the like, the resistance of a material having high light-transmittance such as ITO or IZO or the like is 50 to 200 times greater, and there are cases in which the same bias voltage cannot be applied uniformly to the semiconductor layer 44. Therefore, a common electrode line may be disposed on the upper electrode 46, and bias voltage may be applied to the upper electrode 46 via the common electrode line.

A scintillator 30, that is formed from GOS or the like, is affixed to the X-ray detecting element 10 that is formed in this way, by using an adhesive resin having low light absorbance, or the like.

The operation of the radiation image photographing device 100 relating to the present exemplary embodiment will be described next.

At the radiation image photographing device 100, when a radiation image is photographed, X-rays that have passed through a subject are irradiated onto the X-ray detecting element 10. A high energy component and a low energy component are included in the X-rays that have passed through the subject.

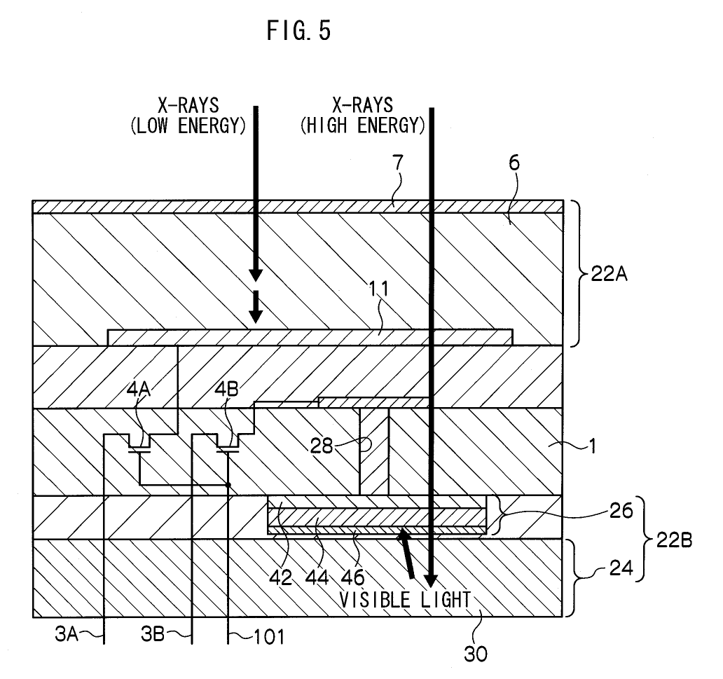

As shown in FIG. 5, at the X-ray detecting element 10, the X-ray detecting sections 22A, 22B are provided at the obverse side and the reverse side respectively of the substrate 1 at each of the pixels 20, and are layered with respect to the direction in which the X-rays are irradiated. Therefore, the low energy X-rays are absorbed at the X-ray detecting section 22A and do not reach the X-ray detecting section 22B. On the other hand, the high energy X-rays pass through the X-ray detecting section 22A and reach the X-ray detecting section 22B. Accordingly, the X-ray detecting section 22A is sensitive to low energy X-rays. On the other hand, the X-ray detecting section 22B is sensitive to high energy X-rays.

At the X-ray detecting section 22A, charges are generated within the semiconductor layer 6 due to X-rays being irradiated on the semiconductor layer 6. At the X-ray detecting section 22B, the X-rays are converted into visible light at the scintillator 30, and due to the converted visible light being illuminated onto the semiconductor layer 8, charges are generated. Note that, in the case of a direct-conversion-type that converts X-rays directly into charges at the semiconductor layer 6 such as the X-ray detecting section 22A, if the semiconductor layer 6 is thick, there are cases in which the charges generated at the semiconductor layer 6 cannot be accumulated sufficiently at the lower electrode 11. Therefore, in the case of a direct-conversion-type, a storage capacitor that accumulates the charges gathered by the lower electrode 11 may be provided.

In the X-ray detecting element 10 relating to the present exemplary embodiment, the X-ray detecting section 22A is a direct-conversion-type, and a-Se (amorphous selenium) is used at the semiconductor layer 6. Further, at the X-ray detecting element 10 relating to the present exemplary embodiment, the X-ray detecting section 22B is an indirect-conversion-type, and GOS is used at the scintillator 30.

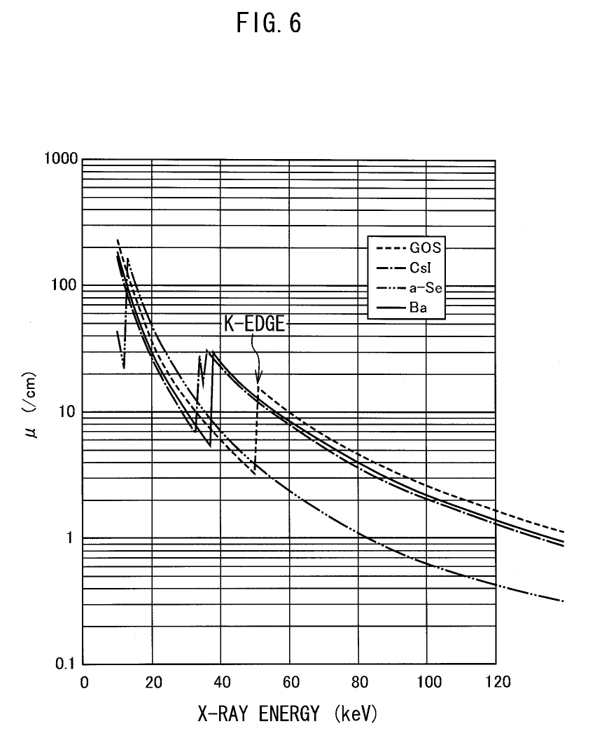

X-ray absorption characteristics of respective materials are shown in FIG. 6.

As shown in FIG. 6, most of the low energy (<40 [KeV]) are absorbed by a-Se. Therefore, although GOS has an absorption rate that is substantially equivalent to that of a-Se, few low energy X-rays reach the scintillator 30 that is at the lower layer. Most of the low energy X-rays are detected at the X-ray detecting section 22A that has the semiconductor layer 6.

On the other hand, a-Se absorbs little of the high energy radiation (>50 [KeV]). In contrast, with GOS, because the K-edge is in the vicinity of 50 [KeV], high energy X-rays can be absorbed efficiently.

Accordingly, at the X-ray detecting element 10 relating to the present exemplary embodiment, the X-ray detecting section 22B that is at the non-irradiated side has higher sensitivity to high energy X-rays than the X-ray detecting section 22A that is at the irradiated side where radiation is irradiated. A preferable condition for the X-ray detecting section 22A is that it does not have a K-edge in the energy range of the X-rays that are used in photographing. The energy range of the X-rays that are used in photographing depends on the atomic number of the constituent element that structures the semiconductor layer 6.

In this way, because the X-ray detecting section 22A photographs the low energy radiation image, it is preferable that the absorption rate μ of X-rays of the low energy portion be greater than or equal to that of the X-ray detecting section 22B. Further, because the X-ray detecting section 22B photographs the high energy radiation image, a combination of materials at which the absorption rate μ of X-rays of the high energy portion is greater than that of the X-ray detecting section 22A is ideal.

In the present exemplary embodiment, the combination of the materials of the semiconductor layer 6 and the scintillator 30 is made to be a-Se and GOS, but a-Se and CsI (cesium iodide), and a-Se and Ba (barium) also suffice. Even with other materials, radiation images by X-rays having different energies can be obtained provided that the combination of materials satisfies the above-described concept.

At the time of reading-out the image, on signals are successively applied to the gate electrodes 2A, 2B of the TFT switches 4A, 4B via the scan lines 101. Due thereto, the TFT switches 4A, 4B are successively turned on. The charges generated at the X-ray detecting sections 22A flow to the signal lines 3A as electric signals. The charges generated at the X-ray detecting sections 22B flow to the signal lines 3B as electric signals.

On the basis of the electric signals that flow-out to the respective signal lines 3A, 3B, the signal detecting circuit 105 detects the charge amounts, that are generated at the X-ray detecting sections 22A and the X-ray detecting sections 22B, as information of the respective pixels structuring the image. The signal processing device 106 divides the information of the respective pixels detected at the signal detecting circuit 105, into image information from the signal lines 3A and image information from the signal lines 3B, and carries out predetermined processings thereon. In this way, image information expressed by the high energy X-rays irradiated on the X-ray detecting element 10, and image information expressed by the low energy X-rays, are obtained.

An energy subtraction image is obtained by carrying out subtraction image processing by using the obtained image information expressed by the high energy X-rays and image information by the low energy X-rays.

As described above, in accordance with the present exemplary embodiment, the X-ray detecting sections 22A, 22B, that generate charges corresponding to the irradiated X-rays, are provide at the obverse side and the reverse side of the substrate 1, and, at each of the pixels 20, the X-ray detecting sections 22A, 22B are disposed so as to be layered in the direction in which the X-rays are irradiated. Therefore, radiation images of two types of energy are obtained by the irradiation of X-rays a single time, without positional offset arising between the pixels of the radiation image expressed by the high energy X-rays and the radiation image expressed by the low energy X-rays that are obtained by the X-ray detecting element 10.

Note that the above exemplary embodiment describes a case in which the X-ray detecting sections 22A, 22B are respectively provided at each of the pixel regions, but the present invention is not limited to the same. For example, at one surface of the substrate 1, the X-ray detecting section 22A and the TFT switch 4A may be provided at each of the pixel regions that detect X-rays in correspondence with the pixels of the radiation image, and, at the other surface of the substrate 1, the X-ray detecting elements 22B, the through-holes 28 and the TFT switches 4B may be provided for each region of plural pixels (e.g., for each region of 2×2 pixels). In the case of obtaining an energy subtraction image, it is preferable that the diagnostic image be a highly-detailed image. However, the images, that are weighted and whose difference is computed for the diagnostic image, do not necessarily have to be highly-detailed images. The transfer time at the time of transferring the image data obtained by photographing can be shortened by reducing the numbers of pixels of the images that are weighted and whose difference is computed in this way. Further, the storage region of the image data can be reduced by reducing the number of images that are weighted and whose difference is computed.

The above exemplary embodiment describes a case in which the X-ray detecting section 22A is a direct-conversion-type, but the present invention is not limited to the same, and for example, the X-ray detecting section 22A may be an indirect-conversion-type. Further, the above exemplary embodiment describes a case in which the X-ray detecting section 22B is an indirect-conversion-type, but the present invention is not limited to the same, and, for example, the X-ray detecting section 22B may be a direct-conversion-type.

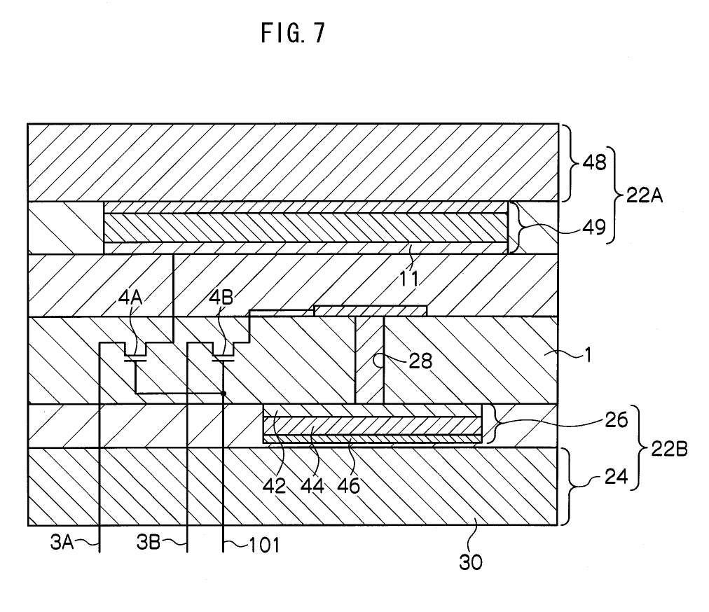

A schematic drawing showing the schematic configuration of one of the pixels 20 of the X-ray detecting element 10 in a case in which the X-ray detecting section 22A is made to be an indirect-conversion-type, is shown in FIG. 7. The X-ray detecting section 22A shown in FIG. 7 has a wavelength converting portion 48 that generates light when X-rays are irradiated, and a sensor portion 49 that generates charges due to the light, that is generated at the wavelength converting portion 48, being illuminated.

Also in the case in which the X-ray detecting section 22A is made to be an indirect-conversion-type as shown in FIG. 7, the X-ray detecting sections 22A, 22B are disposed so as to be layered at each of the pixels 20 of the X-ray detecting element 10. Therefore, radiation images of two types of energy are obtained by the irradiation of X-rays a single time, without positional offset arising between the pixels of the radiation image expressed by the high energy X-rays and the radiation image expressed by the low energy X-rays that are obtained by the X-ray detecting element 10.

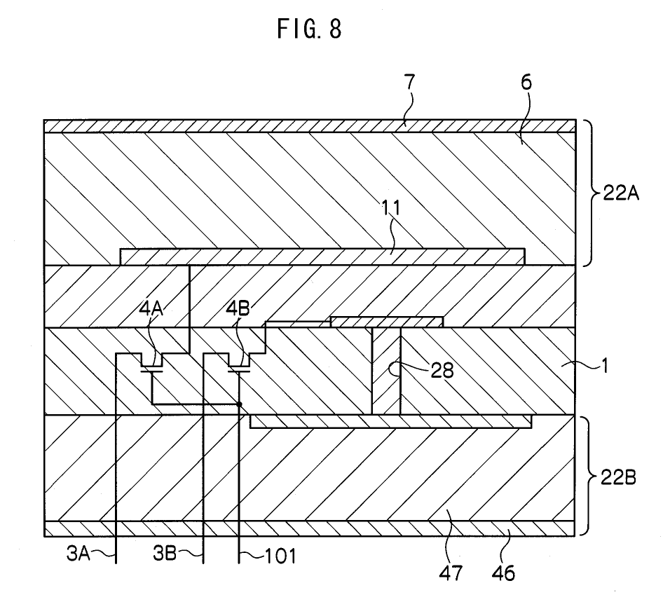

A schematic drawing showing the schematic configuration of one of the pixels 20 of the X-ray detecting element 10 in a case in which the X-ray detecting section 22B is made to be a direct-conversion-type, is shown in FIG. 8. The X-ray detecting section 22B shown in FIG. 8 has a semiconductor layer 47 that generates charges when X-rays are irradiated.

Also in the case in which the X-ray detecting section 22B is made to be a direct-conversion-type as shown in FIG. 8, the X-ray detecting sections 22A, 22B are disposed so as to be layered at each of the pixels 20 of the X-ray detecting element 10. Therefore, radiation images of two types of energy are obtained by the irradiation of X-rays a single time, without positional offset arising between the pixels of the radiation image expressed by the high energy X-rays and the radiation image expressed by the low energy X-rays that are obtained by the X-ray detecting element 10.

Further, in the above-described exemplary embodiment, a filter that absorbs low energy X-rays may be formed between the X-ray detecting sections 22A, 22B (e.g., on the interlayer insulating film 12). In a case in which the X-ray detecting section 22A is formed so as to cover the X-ray detecting section 22B as in the above-described exemplary embodiment, the low energy X-rays are absorbed by the X-ray detecting section 22A. Namely, the X-ray detecting section 22A also functions as a filter that absorbs low energy X-rays. In this way, it is preferable that there be a filter that absorbs low energy X-rays at the X-ray detecting section 22A side of the X-ray detecting section 22B.

Further, the above exemplary embodiment describes a case in which the sensor portion 26 is a PIN photodiode, but the present invention is not limited to the same. For example, the sensor portion 26 may be an MIS photodiode.

The above exemplary embodiment describes a case in which, as shown in FIG. 1, one of the scan lines 101 is provided for each row of pixels in the one direction, and the TFT switches 4A, 4B of the respective pixels 20 of the pixel row are connected to the same scan line 101. However, for example, two of the scan lines 101 may be provided for each of the pixel rows in the one direction, and the TFT switch 4A and the TFT switch 4B of each pixel 20 of a pixel row may be connected to the different scan lines 101, and the TFT switch 4A and the TFT switch 4B may be switched separately. Further, in this case, one of the signal lines 3 may be provided for each of the pixel columns in the intersecting direction, and the TFT switch 4A and the TFT switch 4B may be connected to the same signal line 3.

The above exemplary embodiment describes a case in which an insulator, such as polyimide or the like is used as the substrate 1, but a substrate that is formed from alkaline-free glass or the like may be used. In this case, for example, the through-holes can be formed in the substrate by wet etching or sandblasting.

A case is described in the above exemplary embodiment in which the signal lines 3 are formed at the second signal wiring layer, but the present invention is not limited to the same. The X-ray detecting element 10 may be formed by using a greater number of metal layers.

Further, although the above exemplary embodiment describes a case in which the respective signal wiring layers are formed by metal materials that are conductive, the present invention is not limited to the same. Provided that they are conductive, the respective signal wiring layers are not limited to metal materials.

Although the exemplary embodiment describes a case in which the present invention is applied to an X-ray detecting element that detects images by detecting X-rays that serve as the radiation that is the object of detection, the present invention is not limited to the same. For example, the radiation that is the object of detection may be gamma rays or neutron beams, or may be gamma rays and neutron beams, or the like. Further, the present invention may be applied to a radiation detecting element that, for example, discriminates between energies of gamma rays, or discriminates between neutron beams and gamma rays.

Discriminating between energies of gamma rays is, in principle, similar to the above-described exemplary embodiment, but there is a wider energy range, and the energy is mainly at the high energy side. Therefore, there are cases in which the K-edge is unrelated. The application of a metal foil+scintillator may be considered at the non-irradiated side.

In discriminating between neutron beams and gamma rays, for example, at the irradiated side, radiation is absorbed by 6Li or 10B and secondary particles are generated, and neutron beams are detected by using a scintillator such as ZnS:Ag. On the other hand, a system can be considered in which gamma rays are detected by using a CsI:Tl scintillator at the non-irradiated side, or gamma rays are detected by using an a-Se thick film at the irradiated side, and neutron beams are detected by using Gd2O2S:Tb at the non-irradiated side.

The configuration (see FIG. 1) of the radiation image photographing device 100 and the configuration (see FIG. 2 through FIG. 8) of the X-ray detecting element 10, that are described in the above exemplary embodiment, are examples. Appropriate changes can be made thereto within a scope that does not deviate from the gist of the present invention.

What is claimed is:

1. A radiation detecting element comprising:
an insulating substrate in which is formed a through-hole that opens at an obverse side and a reverse side of the insulating substrate and in which a conductor is formed;
radiation detecting sections provided respectively at the obverse side and the reverse side of the insulating substrate, and generating charges corresponding to irradiated radiation;
a first switching element, provided at one of the obverse side and the reverse side of the insulating substrate and connected to the radiation detecting section provided at the one of the obverse side and the reverse side of the insulating substrate, for reading-out charges generated at that radiation detecting section; and
a second switching element, provided at the one of the obverse side and the reverse side of the insulating substrate and connected via the conductor of the through-hole to the radiation detecting section provided at the other of the obverse side and the reverse side of the insulating substrate, for reading-out charges generated at that radiation detecting section.

2. The radiation detecting element of claim 1, wherein the through-hole, the radiation detecting sections, the first switching element and the second switching element are provided for each pixel region that corresponds to a pixel of a radiation image and detects radiation.

3. The radiation detecting element of claim 1, wherein
the radiation detecting section that is provided at the one of the obverse side and the reverse side of the insulating substrate, and the first switching element, are provided for each pixel region that corresponds to a pixel of a radiation image and detects radiation, and
the radiation detecting section that is provided at the other of the obverse side and the reverse side of the insulating substrate, and the through-hole and the second switching element, are provided per a plurality of the pixel regions.

4. The radiation detecting element of claim 1, wherein the through-hole is disposed at a position that is superposed with the radiation detecting section that is provided at the other of the obverse side and the reverse side of the insulating substrate.

5. The radiation detecting element of claim 1, wherein the radiation detecting section that is at a non-irradiated side has higher sensitivity to high energy radiation than the radiation detecting section that is at an irradiated side where radiation is irradiated.

6. The radiation detecting element of claim 1, wherein
the radiation detecting section that is at an irradiated side where radiation is irradiated is configured to include a semiconductor layer that generates charges when radiation is irradiated, and
the radiation detecting section that is at a non-irradiated side is configured to include a wavelength converting portion that generates light when radiation is irradiated, and a sensor portion that generates charges due to illuminated light that is generated at the wavelength converting portion.

7. The radiation detecting element of claim 1, wherein the radiation detecting section that is at a non-irradiated side has, at an irradiated side, a filter that absorbs low energy radiation.

8. The radiation detecting element of claim 7, wherein the radiation detecting section at the irradiated side also functions as the filter.
